(19) United States
(12) Patent Application Publication
(10) Pub. No.: US 2011/0206777 A1
(43) Pub. Date: Aug. 25, 2011

(54) INORGANIC OXIDE NANO MATERIALS AS ANTI-MICROBIAL AGENTS

(75) Inventors: R. Vijayaraghavan, Vellore (IN); Padmavathy Nagarajan, Vellore (IN)

(73) Assignee: Vellore Institute of Technology

(21) Appl. No.: 12/754,366

(22) Filed: Apr. 5, 2010

(30) Foreign Application Priority Data
Feb. 20, 2010 (IN) 436/CHE/2010

(51) Int. Cl. A01N 59/16

(52) U.S. Cl. 424/641

(57) ABSTRACT

An anti-microbial composition includes a doped zinc oxide of formula Zn₁₋ₙMₙO, where M is an alkali metal ion, an alkaline earth metal ion, a lanthanide metal ion, or a mixture of any two or more thereof; and n is about 0.05 to about 0.2.

### CROSS-REFERENCE TO RELATED APPLICATION

This application claims priority to India Patent Application No. 436/CHE/2010, filed Feb. 20, 2010, the entire contents of which are incorporated by reference herein and for all purposes as if fully set forth herein.

### TECHNOLOGY

The present technology is related in general to anti-microbial agents.

### SUMMARY

In one aspect, an anti-microbial composition is provided including a doped zinc oxide of formula Zn₁₋ₙMₙO, where M is an alkali metal ion, an alkaline earth metal ion, a lanthanide metal ion, or a mixture of any two or more thereof, and n is about 0.05 to about 0.2. In some embodiments, n is about 0.15. In some embodiments, M is an alkali metal ion that is Li⁺, Na⁺, K⁺, or a mixture of any two or more such metals. As used herein, anti-microbial includes anti-bacterial as well as referring to microbes in general. In some embodiments, M is an alkaline earth metal ion that is Ca²⁺ or Mg²⁺, or a mixture. In some embodiments, M is a lanthanide metal ion that is La³⁺, Ce³⁺, Pr³⁺, Nd³⁺, Pm³⁺, Sm³⁺, Eu³⁺, Gd³⁺, Tb³⁺, Dy³⁺, Ho³⁺, Er³⁺, Tm³⁺, Yb³⁺, Lu³⁺, or a mixture of any two or more such metals.

In another aspect, a method is provided for preparing a doped zinc oxide of formula Zn₁₋ₙMₙO including mixing a zinc nitrate with a nitrate of an alkali metal ion, a nitrate of an alkaline earth metal ion, a nitrate of a lanthanide metal ion, or a mixture of any two or more such nitrates to form a precursor mixture, in a molar stoichiometric ratio of 1−n Zn to n M; and heating the precursor mixture to form the doped zinc oxide, where M is an alkali metal ion, an alkaline earth metal ion, a lanthanide metal ion, or a mixture of any two or more such metal ions; and n is about 0.05 to about 0.2. In some embodiments, n is about 0.15. In some embodiments, the heating is conducted at a temperature of from about 400° C. to about 1000° C., from about 400° C. to about 900° C., from about 400° C. to about 800° C., from about 400° C. to about 700° C., or from about 400° C. to about 600° C. In some embodiments, the zinc nitrate is of formula Zn (NO₃)₂.x H₂O, where x is from 0 to 6. In some embodiments, the nitrate of the lanthanide metal ion is of formula La(NO₃)₃.x H₂O, Ce(NO₃)₃.x H₂O, Pr(NO₃)₃.x H₂O, Nd(NO₃)₃.x H₂O, Pm(NO₃)₃.x H₂O, Sm(NO₃)₃.x H₂O, Eu(NO₃)₃.x H₂O, Gd(NO₃)₃.x H₂O, Tb(NO₃)₃.x H₂O, Dy(NO₃)₃.x H₂O, Ho(NO₃)₃.x H₂O, Er(NO₃)₃.x H₂O, Tm(NO₃)₃.x H₂O, Yb(NO₃)₃.x H₂O, Lu(NO₃)₃.x H₂O, or a mixture of any two or more such nitrates, and x is from 0 to 6. In some embodiments, the nitrate of the rare earth metal ion is of formula Ca(NO₃)₂.x H₂O, where x is from 0 to 6. In some embodiments, the nitrate of the alkaline earth metal ion is of formula NaNO₃.x H₂O, where x is from 0 to 6.

In some embodiments, the method also includes mixing a fuel with the precursor mixture. In some such embodiments, the fuel is urea. In other embodiments, the method also includes adding an oxidant during the heating. In some embodiments, the oxidant is HNO₃. In some embodiments, a ratio of fuel to oxidizer is about 1.11 to 1. In some embodiments, where the method includes the use of a fuel, the precursor mixture is dissolved in water.

### BRIEF DESCRIPTION OF THE DRAWINGS

FIG. 1 is photoluminescent (PL) spectrum of Na⁺ doped ZnO sample (x=0.15) incubated at 37° C. with E. coli and an E. coli control after 24 h, according to various embodiments.

FIG. 2 is a graph of bactericidal activity of Na⁺-, La⁺³-, and Ca⁺²-doped zinc oxides, according to various embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. The present technology is also illustrated by the examples herein, which should not be construed as limiting in any way.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

According to one aspect, an anti-microbial composition containing a metal-doped zinc oxide is provided. Metal-doped zinc oxides that may be used in the anti-microbial compositions include those of formula Zn₍₁₋ₙ₎MₙO, where n is from 0.05 to about 0.2; and M is an alkali metal ion, an alkaline earth metal ion, a lanthanide metal ion, or a mixture of any two or more such ions. In some embodiments, n is about 0.15. In some embodiments, M is an alkali metal ion that is Li⁺, Na⁺, K⁺, or a mixture of any two or more such ions. In some such embodiments, M is Na⁺. In other embodiments, M is an alkaline earth metal ion that is Ca²⁺ or Mg²⁺, or a mixture of Ca²⁺ and Mg²⁺. In further embodiments, M is a lanthanide metal ion that is La³⁺, Ce³⁺, Pr³⁺, Nd³⁺, Pm³⁺, Sm³⁺, Eu³⁺, Gd³⁺, Tb³⁺, Dy³⁺, Ho³⁺, Er³⁺, Tm³⁺, Yb³⁺, Lu³⁺, or a mixture of any two or more such ions.

Such anti-microbial activity of an inorganic oxide is a useful property that can substitute for conventional anti-microbial methods that use organic compounds. Inorganic oxides are generally more thermally stable, and less expensive than the organic compounds. For example, organic anti-microbial agents tend to have low thermal stability, high decomposability, and short life expectancy. Whereas, inorganic compounds tend to have high thermal stability, do not decompose, and have long life and activity expectancies.

The anti-microbial activity of the compositions can be measured by measuring the minimum bactericidal concentration (MBC) and the minimum inhibitory concentration (MIC). According to some embodiments, the activity of the compounds is measured using non-pathogenic gram negative bacterial strains. According to other embodiments, microorganisms such as E. coli JM101 (a gram −ve, model organism); S. aureus RN6390 (a gram +ve, pathogen); B. subtilis 168 (a gram +ve—model organism); Klebsiella oxytoca ATCC43863 (a gram −ve, pathogen); or Proteus mirabilis H14320 (a gram −ve, pathogen). Other microorganims may be tested for activity as well, for example, other bacterias, fungi, viruses, and the like may used and tested with the compositions for activity of those compositions against any particular microorganism. The analyses may be conducted by methods known to those of skill in the art including, but not limited to, conductometric assays which involves detection as a function time by measurement of conductance as it varies with bacterial count; flow cytometry which uses staining with dyes for fluorometry assays; broth/Agar dilutions as standard microbial methods using disc diffusion assays; confocal laser methods using high resolution imaging of live and dead bacterial cells by staining with proper dyes; electron paramagnetic resonance (EPR) methods which involves the study of oxygen species generated at the metal oxide surface in suspensions to induce oxidative stress to bacterial cells; inductively coupled plasma (ICP) analysis which determines the concentration of metal ions before and after the treatment of metal oxides with bacteria; chemiluminescence assays for determining the presence of hydrogen peroxide developed at the metal oxide surface using fluorescent probes; electrochemical analyses which determines changes in electrical conductivity based on the decrease in the growth of bacterial cells with metal oxides; and UV light source methods using photoactivation of semiconductor metal oxides such as TiO₂ and ZnO with bacteria.

As used herein, the MBC is the lowest concentration (μg/ml⁻¹) at which a compound will kill more than 99% of the added bacteria. The MIC of the agent is the lowest concentration at which the solution does not become turbid. A lower MIC corresponds to higher anti-microbial effectiveness. In terms of both MIC and MBC, there is an inverse relationship between the particle size and activity, with high activity compounds being of smaller particle size, and larger particle size materials exhibiting reduced activity. Thus, in some embodiments, the anti-microbial compositions contain nanometer size metal-doped zinc oxides. In other embodiments, the anti-microbial compositions contain micrometer size metal-doped zinc oxides.

In some embodiments, the MBC of the metal-doped zinc oxide ranges from about 10 μg/mL to about 100 μg/mL. According to some embodiments, the MBC of Na⁺-doped zinc oxide is about 15 μg/mL. According to some embodiments, the MBC of Ca²⁺-doped zinc oxide is about 77 μg/mL. According to some embodiments, the MBC of La³⁺-doped zinc oxide is from about 92 μg/mL.

In some embodiments, the size of a metal-doped zinc oxide particle is from about 100 nm to about 3 μm. In some embodiments, the size of a metal-doped zinc oxide particle is from about 100 nm to about 2 μm. In some embodiments, the size of a metal-doped zinc oxide particle is less than about 200 nm.

Doping of the zinc oxide with the various metal ions results in the replacement of some of the zinc ions. According to some embodiments, from about 5 wt % to about 15 wt % of the zinc is exchanged fro the metal that is doped. Zinc ion (Zn⁺²) has an ionic radius of 0.74 Å. The other ions have the following ionic radii: sodium (Na⁺) 0.99 Å; lanthanum (La⁺³) 1.032 Å; and calcium (Ca⁺²) 1.0 Å. Those ions in which the charge on the metal is the same as that for zinc are referred to isovalent with zinc. In other words, ions such as calcium which have a 2+ charge are isovalent. Those ions in which the charge on the metal is different from that of zinc are referred to as aliovalent.

The anti-microbial activity depends on the particular metal that is doped into the zinc oxide, the particle size, surface defects, morphology, and the quantity of reactive oxygen species that may be generated on the surface of zinc oxide. For example, particle size has a direct impact on the surface area to volume ratio, with higher surface areas exhibiting enhanced biocidal activity. For smaller nanoparticles, more particles are needed to cover a bacterial colony, which results in the generation of a larger number of active oxygen species, which kill bacteria more effectively.

Oxygen vacancies in the zinc oxide host matrix are another factor which increases the biocidal activity of zinc oxide. Without being bound by theory, it is believed that when aliovalent metal ions, such as Na⁺ (a lower valency cation) are doped into ZnO, they create oxygen vacancies to maintain neutrality in the crystal structure. These vacancies are also exhibited at the surface of the material and are generally termed as surface defects. When such a surface is contacted with a bacteria, the proteins which are located at the outer membrane of the bacteria, and having key functional groups such as, but are not limited to, R—S—R, R—SH, RS⁻, —S—S— or PR₃, where R refers to organic groups such as peptide sequences that surround the grouping shown, bind to the defect area thus binding the bacteria to the doped ZnO. Such binding is believed to lead to the death of bacteria that are in contact with, or in close proximity to, the doped zinc oxide.

In another aspect, methods of preparing metal-doped zinc oxides are provided. Such methods are based upon a combustion process in which the synthesis is carried out by mixing starting materials and then firing the mixture. Doped metal zinc oxides that may be produced by the methods include those of formula Zn₍₁₋ₙ₎MₙO, where n is from 0.05 to about 0.2; and M is an alkali metal ion, an alkaline earth metal ion, a lanthanide metal ion, or a mixture of any two or more such ions. In some embodiments, n is about 0.15.

Thus, in some embodiments, the method includes mixing a zinc nitrate with a nitrate of an alkali metal ion, a nitrate of an alkaline earth metal ion, a nitrate of a lanthanide metal ion, or a mixture of any two or more such nitrates to form a precursor mixture. The precursor mixture is to be of the appropriate stoichiometric ratio of the metal(s) to zinc. Thus, in some embodiments, the precursor mixtures includes 1−n moles of Zn to n moles of M. The precursor mixture is then heated to from a metal-doped zinc oxide of formula Zn₍₁₋ₙ₎MₙO.

In some embodiments, the heating is conducted at a temperature of from about 400° C. to about 1000° C., from about 400° C. to about 900° C., from about 400° C. to about 800° C., from about 400° C. to about 700° C., or from about 400° C. to about 600° C. In other embodiments, the temperature is about 500° C.

As noted above, nitrates of various metals may be used. Such nitrates include, but may not be limited to, where the nitrate of the lanthanide metal ion is of formula La(NO₃)₃.x H₂O, Ce(NO₃)₃.x H₂O, Pr(NO₃)₃.x H₂O, Nd(NO₃)₃.x H₂O, Pm(NO₃)₃.x H₂O, Sm(NO₃)₃.x H₂O, Eu(NO₃)₃.x H₂O, Gd(NO₃)₃.x H₂O, Tb(NO₃)₃.x H₂O, Dy(NO₃)₃.x H₂O, Ho(NO₃)₃.x H₂O, Er(NO₃)₃.x H₂O, Tm(NO₃)₃.x H₂O, Yb(NO₃)₃.x H₂O, Lu(NO₃)₃.x H₂O; the nitrate of the rare earth metal ion is of formula Ca(NO₃)₂.x H₂O; and the nitrate of the alkaline earth metal ion is of formula NaNO₃.x H₂O, where x is from 0 to 6. The zinc nitrate is of formula Zn (NO₃)₂.x H₂O, where x is from 0 to 6. In some embodiments, a Na⁺-doped ZnO is formed from zinc nitrate and sodium nitrate.

The methods of formation may also include using a fuel during the heating to promote ignition of the precursor material and drive the formation of the metal-doped zinc oxide. Suitable fuels include, but are not limited to, glycine, alanine, urea, hydrazine, sucrose, citric acid, tetra formyl trisazine, carbohydrazide, cellulose, starch, mixtures of any two or more thereof, and the like. For example, urea, C(O)(NH₂)₂, may be used as a fuel in such methods. The appropriate fuel to oxidizer ratio should be used to promote complete combustion. Thus, in some embodiments, a ratio of fuel to oxidizer is about 1.11 to 1.

The method may include adding an oxidant to the precursor mixture to promote metal oxide formation. Thus, in some embodiments, an oxidant such as nitric acid may be added to the precursor mixture, or it may be product of the reaction being formed from the metal nitrates and water. The addition of the oxidant, such as nitric acid, also allows for adjustment of the pH of the precursor mixture.

To promote formation of the mixing of the individual components of the precursor mixture, the metal nitrates, the fuel, and/or the oxidizer may first be dissolved in water. The amount of water to be used is a small amount, just enough to produce a homogeneous solution after stirring.

According to some embodiments, the nitrate reactants are brought together in a reaction vessel, such as a beaker, ceramic boat, platinum crucible, or like vessel that can withstand high temperatures, without breaking down or introducing other elements to the precursor mixture. A small amount of water may then be added and the mixture stirred for about one hour, or at least of a sufficient time period, to produce a homogeneous solution of the precursor mixture. The precursor mixture is then heated to about 120° C. to about 150° C. As the water evaporates, the mixture will begin to froth. Once frothing begins, the mixture may be transferred to a muffle furnace that has been preheated to about 500° C., where ignition takes place. After 3-5 minutes, a dry, white, and fragile foam of the metal-doped zinc oxide is formed and which an can readily be crumbled into powder.

The nature of the fuel, its amount, and pH of the starting solution are variables that may be adjusted to ensure a homogeneous mixture of reactants and to avoid phase separation or precipitation during dissolution. The powder characteristics of the metal-doped zinc oxide that is obtained by the combustion technique are primarily dependent on the enthalpy or the flame temperature generated during the combustion. The enthalpy, or flame temperature, are a function of the nature of the fuel and fuel-to-oxidant ratio used in the process. The single step decomposition of the precursor during auto-ignition allows for cooling of the resultant powder product through a rapid evolution of the gases, and this facilitates the generation of the product with high surface area and also free from hard agglomerates. At a fuel to oxidizer ratio of about 1.11 to 1, a fuel-rich mixture is obtained, which implies that the oxygen content of metal nitrates can be completely reacted to oxidize/consume urea completely.

The length of the heating of the mixture in the furnace may be adjusted to control grain growth of the forming metal-doped zinc oxide. The stirring to ensure a homogeneous mixture and the length of heating act to prevent Oswald ripening of the mixture. Oswald ripening is a process by which the metal oxides begin to precipitate from solution causing an inhomogeneous product.

In another aspect, the anti-microbial compositions may be included in a wide variety of applications in which bacterial or microbial contamination may be of a concern. For example, medical devices are provided including the anti-microbial compositions containing a metal-doped zinc oxide. The metal-doped zinc oxide may be incorporated as a coating or film on the medical device, or may be incorporated into the material forming the device. Such medical devices may be inserted or implanted into patients or into aqueous environments where bacterial control is desired (e.g., sterilization solutions, food materials, beverages, wash solutions, industrial solutions, cleaning solutions, and the like).

The anti-microbial compositions may also be incorporated into coatings for such devices that controllably releases free radicals into the vicinity of the device. These devices may have coatings of these inorganic anti-microbial agents that alter their rate of flow release or elution release of an anti-microbial agent from a coating on the device upon external stimulation or external activation. Semiconductor materials capable of emitting radiation (e.g., UV radiation that can be generated internally from the semiconductor to activate free radicals) may be used to control release of free radicals.

In other embodiments, the metal-doped zinc oxide anti-microbial compositions may be used in a various applications. For example, the metal-doped zinc oxide anti-microbial compositions may be used in home electrical appliances such as, but not limited to, refrigerators, washing machines, vacuum cleaners, air conditioners, humidifiers, water cleaners, dishwashers, rice cookers, or telephones; kitchen and bath items such as, but not limited to, chopping boards, rice scoops, sponge scrubbers, trash bags, rice bins, chopsticks, wash basins, stools, bathtubs, interior bars, toilet seats, toothbrushes, cups, or cosmetics containers; office equipment such as, but not limited to, pens, pocket books, file folders, copiers, floppy discs, binders, erasers, writing paper, or desk mats; construction materials such as, but not limited to, wall paper, flooring, resin tile, handrail for stairs, carpet, paint, sealing materials, concrete, sanitary ceramics, tile, counters, push buttons for elevators, or door knobs; home furniture such as, but not limited to, tables, table cloths, chairs, sofas, or cupboards; textiles such as, but not limited to, clothing, bed clothes and mattresses, fasteners, nose and mouth masks, gloves, towels, hats, wigs, or curtains; packing materials such as, but not limited to, cardboard, coatings, tape, or films; medical products such as, but not limited to, touch panels of medical instruments, bandages, robes, or prosthetics; or sporting goods such as, but not limited to, gloves, shoes, and tools of sport. Such listing is far from exhaustive and is only provided as an illustration of the myriad of uses for such anti-microbial compositions.

### EXAMPLES

The present technology is further illustrated by the following examples, which should not be construed as limiting in any way.

Metal-doped zinc oxide: Predetermined, weighed amounts of metal nitrates (source of zinc, lanthanum, sodium and calcium) as cation precursors are combined in stoichiometric ratios to produce doped zinc oxides. The cation precursors are then combined with urea in a ratio of about 1.11:1. The reactants are then dissolved in small quantity of distilled water in a reaction vessel and stirred for about 1 h to provide a homogenous solution at ambient temperature. The reactants are then heated at about 120° C. to about 150° C. As the reaction proceeds, the liquid begins frothing, at which point the reaction vessel is transferred to a muffle furnace that has been preheated to about 500° C. Heating and ignition of the mixture takes place in the muffle furnace. After 3-5 minutes, a dry, white, and very fragile foam can be readily crumbled into a powder of the doped zinc oxide.

Anti-Bacterial Activity of Doped zinc oxide: For anti-bacterial experiments, E. coli, a Gram negative bacterium, was selected as the target organism. All disks and materials were sterilized in an autoclave before the experiments. Luria Bertani (LB) broth and nutrient agar were used as sources for culturing E. coli at 37° C. on a rotary platform in an incubator. The density of bacterial cells in the liquid cultures was estimated by optical density (OD) measurements at 600 nm wavelength and was maintained at 0.8-1.0, which is the ideal optical density of the cells. The cell suspensions used for anti-bacterial activity contained 10⁵ colony-forming units (CFU) ml⁻¹. The anti-bacterial activity of the metal-doped ZnO was measured by paper disk diffusion assay in terms of minimum inhibitory concentration (MIC) and minimum bactericidal concentration (MBC). The Petri plates used in the tests were prepared using a nutrient agar medium. The bacteria were spread evenly on top of the plates using a sterile glass rod. After allowing the bacteria to dry (within 5-10 min) test solutions of the metal-doped ZnO of various concentrations were dropped within a disk of 8 mm diameter. The zone of inhibition was measured after 18 h incubation.

To evaluate the MIC, an appropriate volume of 10⁵ CFU ml⁻¹ E. coli in LB broth was added to the metal-doped ZnO suspensions whose concentrations varied from 0.01 to 100 mM. Tests were completed three times and the results were averaged. Negative and positive control tubes contained only inoculated broth and free metal-doped ZnO solution, respectively. The tubes were incubated at 37° C. for 18-20 h. The visual turbidity of the tubes was noted before and after incubation. Aliquots from tubes (100 Ξl) that appeared to have little or no cell growth were plated on nutrient agar plates to distinguish between the bacteriostatic and bactericidal effects. The plates were then incubated and the colonies were quantified. The minimum bactericidal concentration (MBC) and minimum inhibitory concentration (MIC) of each test sample are then determined. The MBC/MIC are expressed in μg/mL as the compounds are provided in suspension form.

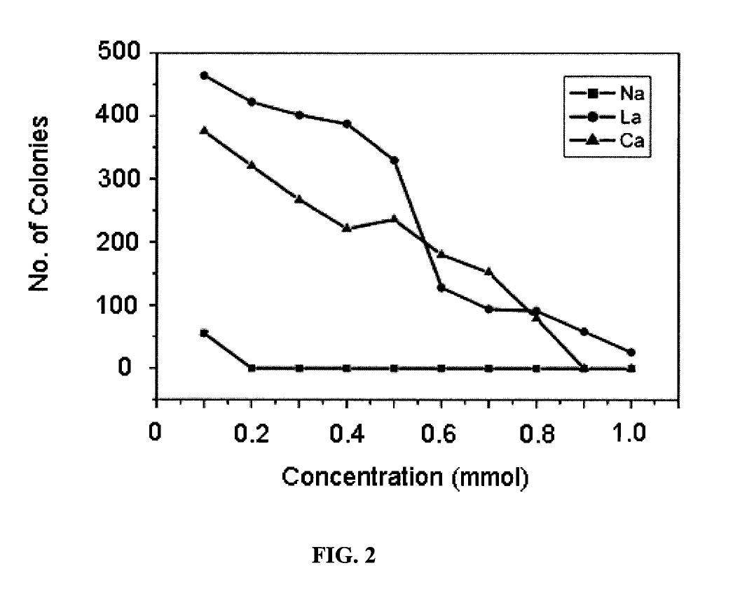

Various metal doped ZnO suspensions (0.1-1 mmol) are depicted in FIG. 2. Of the three dopants, used, Na⁺-doped ZnO is more effective and shows maximum bactericidal efficacy, even at lower concentrations. For example, at 0.2 mmol the Na⁺-doped ZnO is more than 97% effective in biocidal activity. As shown in FIG. 2, La⁺³-doped ZnO, shows inhibition starting at about 0.9 mmol. The activity of Ca⁺²-doped ZnO is similar to that of undoped ZnO, which shows an MIC of about 1 mmol.

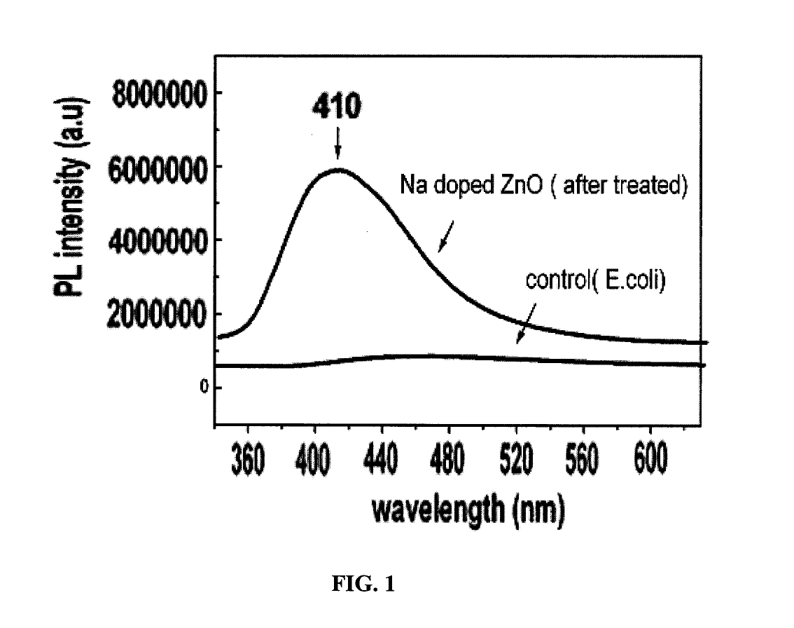

Without being bound by theory, it is believed that surface defects on the metal-doped zinc oxide ceramic are responsible for at least partial bactericidal activity. It is shown in FIG. 1 that bacteria react with the surface of the metal-doped zinc oxide to “fill-in” the surface defects and therefore the two entities are interacting. The PL spectrum of Na⁺-doped zinc oxide with and without E. coli bacteria appear to support this inference. As shown in FIG. 1, the Na⁺-doped ZnO shows a large PL emission at approximately 410 nm, however in the presence of the bacteria this emission is quenched. Thus, the bacteria are apparently filling in the defects that are responsible for the emission.

### EQUIVALENTS

While certain embodiments have been illustrated and described, it should be understood that changes and modifications can be made therein in accordance with ordinary skill in the art without departing from the technology in its broader aspects as defined in the following claims.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

Other embodiments are set forth in the following claims.

What is claimed is:

1. An anti-microbial composition comprising:
a doped zinc oxide of formula Zn₁₋ₙMₙO;
wherein:
M is an alkali metal ion, an alkaline earth metal ion, a lanthanide metal ion, or a mixture of any two or more thereof; and
n is about 0.05 to about 0.2.

2. The anti-microbial composition of claim 1, wherein M is an alkali metal ion that is Li⁺, Na⁺, K⁺, or a mixture of any two or more thereof.

3. The anti-microbial composition of claim 2, wherein M is Na⁺.

4. The anti-microbial composition of claim 1, wherein M is an alkaline earth metal ion that is Ca²⁺ or Mg²⁺, or a mixture thereof.

5. The anti-microbial composition of claim 1, wherein M is a lanthanide metal ion that is La³⁺, Ce³⁺, Pr³⁺, Nd³⁺, Pm³⁺, Sm³⁺, Eu³⁺, Gd³⁺, Tb³⁺, Dy³⁺, Ho³⁺, Er³⁺, Tm³⁺, Yb³⁺, Lu³⁺, or a mixture of any two or more thereof.

6. The anti-microbial composition of claim 1, wherein n is about 0.15.

7. A method of preparing a doped zinc oxide of formula Zn₁₋ₙMₙO comprising:
mixing a zinc nitrate with a nitrate of an alkali metal ion, a nitrate of an alkaline earth metal ion, a nitrate of a lanthanide metal ion, or a mixture of any two or more thereof to form a precursor mixture, in a stoichiometric ratio of (1−n) moles of Zn: n moles of M; and
heating the precursor mixture to form the doped zinc oxide;
wherein:
M is an alkali metal ion, an alkaline earth metal ion, a lanthanide metal ion, or a mixture of any two or more thereof; and
n is about 0.05 to about 0.2.

8. The method of claim 7, wherein the heating is conducted at a temperature of from about 400° C. to about 1000° C., from about 400° C. to about 900° C., from about 400° C. to about 800° C., from about 400° C. to about 700° C., or from about 400° C. to about 600° C.

9. The method of claim 8, wherein the temperature is about 500° C.

10. The method of claim 7, wherein the zinc nitrate is of formula Zn (NO₃)₂.x H₂O, wherein x is from 0 to 6.

11. The method of claim 7, wherein the nitrate of the lanthanide metal ion is of formula
La(NO₃)₃.x H₂O, Ce(NO₃)₃.x H₂O, Pr(NO₃)₃.x H₂O, Nd(NO₃)₃.x H₂O,
Pm(NO₃)₃.x H₂O, Sm(NO₃)₃.x H₂O, Eu(NO₃)₃.x H₂O, Gd(NO₃)₃.x H₂O,
Tb(NO₃)₃.x H₂O, Dy(NO₃)₃.x H₂O, Ho(NO₃)₃.x H₂O, Er(NO₃)₃.x H₂O,
Tm(NO₃)₃.x H₂O, Yb(NO₃)₃.x H₂O, Lu(NO₃)₃.x H₂O, or a mixture of any two or more thereof, and x is from 0 to 6.

12. The method of claim 7, wherein the nitrate of the rare earth metal ion is of formula Ca(NO₃)₂.x H₂O, wherein x is from 0 to 6.

13. The method of claim 7, wherein the nitrate of the alkaline earth metal ion is of formula NaNO₃.x H₂O, wherein x is from 0 to 6.

14. The method of claim 7 further comprising mixing a fuel with the precursor mixture.

15. The method of claim 14, wherein the fuel is urea.

16. The method of claim 14 further comprising adding an oxidant during the heating.

17. The method of claim 15, wherein the oxidant is HNO₃.

18. The method of claim 15, wherein a ratio of fuel to oxidizer is about 1.11 to 1.

19. The method of claim 14 further comprising dissolving the precursor mixture in water.

20. The method of claim 7, wherein n is about 0.15.
